(19) United States
(12) Patent Application Publication
(10) Pub. No.: US 2008/0258603 A1
(43) Pub. Date: Oct. 23, 2008

(54) Color display device

(75) Inventors: Koji Shinohe, Kobe (JP); Manabu Ishimoto, Kobe (JP); Kenji Awamoto, Kobe (JP); Hitoshi Hirakawa, Kobe (JP); Yosuke Yamazaki, Kobe (JP)

Correspondence Address: STAAS & HALSEY LLP, SUITE 700, 1201 NEW YORK AVENUE, N.W., WASHINGTON, DC, 20005, US

(73) Assignee: SHINODA PLASMA CO., LTD., Kobe (JP)

(21) Appl. No.: 12/213,568

(22) Filed: Jun. 20, 2008

Related U.S. Application Data
(63) Continuation of application No. PCT/JP2005/023638, filed on Dec. 22, 2005.

(51) Int. Cl. H01J 1/62

(52) U.S. Cl. 313/487

(57) ABSTRACT

A color display device (10) includes: a plurality of gas discharge tubes disposed side by side, the gas discharge tubes having phosphor layers (4R, 4G, 4B) of different materials for respective colors disposed therein and containing discharge gas therein, the gas discharge tubes each having a plurality of light-emitting points disposed along the length thereof; a plurality of display electrodes disposed on display-side surfaces of the gas discharge tubes; and a plurality of signal electrodes (3) disposed on the rear sides of the respective gas discharge tubes. The discharge gas in each of the plurality of gas discharge tubes comprises a mixture of a plurality of different gases. The gas discharge tubes including respective different materials for the phosphor layers have respective different compositions of the plurality of different gases. Each composition of the plurality of different gases has such respective partial pressure ratios as to raise a color temperature.

This application is a continuation application of international application PCT/JP2005/23638 filed Dec. 22, 2005.

### FIELD OF THE INVENTION

The present invention relates generally to a color display device having color phosphor layers, and, more particularly, to a color display device employing discharge-induced light-emission elements having phosphor layers of different materials.

### BACKGROUND OF THE INVENTION

A plasma tube array (PTA) and a plasma display panel (PDP) are known as a thin color display device employing discharge-induced light-emission elements (see JP 2004-178854-A).

Japanese Patent Application Publication No. 2003-346660-A describes a plasma display panel. The plasma display panel uses a discharge-gas mixture containing three component gases, Xe, Ne and He. A ratio of Xe in the mixture discharge-gas composition is in a range from 2% to 20%, and a percentage of He in the mixture discharge-gas composition is in a range from 15% to 50%, where the percentage of He is greater than the percentage of Xe. A total pressure of the discharge-gas mixture is in a range from 400 Torr to 550 Torr. A width of a voltage pulse to be applied to address electrodes is 2 μs or less.

Japanese Patent Application Publication No. 2002-93327-A describes a plasma display panel. In the plasma display panel, the amount of xenon in discharge gas is provided in the range of 10% by volume to less than 100% by volume, and the pressure of the discharge gas is provided in the range of 500 Torr or more which is higher than a conventional discharge gas pressure, whereby a luminous efficiency of ultra violet ray and a conversion efficiency by phosphor are improved, and the panel brightness increases. A protecting layer consisting of an alkaline earth oxide with (100)-face or (110)-face orientation is provided on the surface of the dielectrics glass layer. The protecting layer, which may be formed by the thermal Chemical Vapor Deposition (CVD) method, the plasma enhanced CVD method, or the vapor deposition method with irradiation of ion or electron beam, will have a high sputtering resistance and effectively protect the dielectrics glass layer. Such a protecting layer extends the panel lifetime.

Japanese Patent Application Publication No. HEI 11-185646-A describes a plasma display panel. In a gas discharge panel, the pressure of discharge gas is set in a range of 800-4000 Torr, that is higher than a conventional gas pressure. Light-emission efficiency and brightness of the panel can be further enhanced than a conventional technique. Also, a rare gas mixture containing helium, neon, xenon and argon is used as discharge gas within the panel, instead of conventional discharge gas. It is preferable to provide a ratio of Xe set in a rage of 5% by volume or less, a ratio of Ar set in a range of 0.5% by volume or less, and a ratio of He in a rage less than 55% by volume. With this rare gas mixture, the luminous efficiency is improved and the firing voltage can be lowered.

### DISCLOSURE OF THE INVENTION

In a plasma display panel (PDP), a discharge is generated in a minute closed space, and phosphors are excited with vacuum ultraviolet light (at 147 nm) emitted from discharge plasma to emit light. The minute, closed space is provided by a gap formed between planar glass plates superposed one on another. In a prior PDP, a planar glass substrate is used to provide a display screen. Due to different properties of color phosphors, discharge characteristics and lifetimes of different color cells differ. Since the panel can be filled with only one gas composition, it is structurally impossible to use different gas compositions for different emission colors. For example, in order to produce white color having a proper color temperature, keeping the balance in luminosity among the colors R, G and B, different thicknesses are employed for different color phosphors. Also, in order to provide different color cells with equal firing delays and firing voltages, for example, it is necessary to subtly prepare color phosphor materials. This is costly and gives a narrow range of adjustment of white color temperature.

In gas discharge tubes with color phosphor layers of different materials, as the thickness of a color phosphor layer increases for a color temperature, the luminosity increases. Accordingly, different thicknesses are commonly used for the respective color phosphor materials to provide white balance in luminosity for R, G and B, so that white color at an appropriate color temperature can be emitted. However, improvement in luminosity provided by the adjustment of the thicknesses of the color phosphor layers is limited, in which the range of adjustment of luminosity is narrow. Accordingly, it is impossible to provide a wide range of the color temperature adjustment of white light.

The inventors have recognized that the white balance in luminosity of the R, G and B colors can be adjusted over a wide range by filling the gas discharge tubes with respective feature discharge gases adapted to increase the luminosity depending on the color phosphor materials of the gas discharge tubes.

An object of the present invention is to provide a wide range of adjusting white balance in a display device including gas discharge tubes having respective different color phosphor material layers.

### SUMMARY OF THE INVENTION

In accordance with an aspect of the present invention, a color display device includes: a plurality of gas discharge tubes disposed side by side, the gas discharge tubes having phosphor layers of different materials for respective colors disposed therein and containing discharge gas therein, the gas discharge tubes each having a plurality of light-emitting points disposed along the length thereof; a plurality of display electrodes disposed on display-side surfaces of the gas discharge tubes; and a plurality of signal electrodes disposed on the rear sides of the respective gas discharge tubes. The discharge gas in each of the plurality of gas discharge tubes includes a mixture of a plurality of different gases. The gas discharge tubes including respective different materials for the phosphor layers have respective different compositions of the plurality of different gases. Each composition of the plurality of different gases has such respective partial pressure ratios as to raise a color temperature.

According to embodiments of the invention, a wide range of adjustment of white balance can be achieved in a display device including discharge-induced light-emission elements having different, plural color phosphor layers, whereby non-uniformity in color can be reduced, variations in firing voltage characteristic can be corrected, and a wide drive margin can be obtained for the display device having different color phosphor layers. In particular, when the invention is embodied in a plasma tube array type color display device having a structure in which discharge spaces for the respective emission colors are completely independent from each other, the difference in firing voltages can be made smaller to increase the drive margin.

### BRIEF DESCRIPTION OF THE DRAWINGS

FIG. 1 shows an example of the structure of part of a large display device of a plasma tube array type, in accordance with an embodiment of the present invention;

FIG. 2A shows a front support with a plurality of pairs of transparent display electrodes formed thereon, and FIG. 2B shows a rear support with the plurality of signal electrodes formed thereon;

FIG. 3 shows the cross-section of the structure of a display device in a plane perpendicular to the longitudinal direction, in accordance with the embodiment of the invention;

FIG. 4 shows the relationship of luminosity of white light to a partial pressure ratio of xenon (Xe) gas in a gas mixture of neon (Ne) and xenon in the gas discharge tubes including color phosphor layers of different materials; and

FIGS. 5A, 5B and 5C show the relationship of luminosity to a partial gas ratio of Xe gas in a gas mixture of Ne and Xe in the respective ones of the gas discharge tubes.

### DESCRIPTION OF THE PREFERRED EMBODIMENTS

The invention will be described with reference to the accompanying drawings. Throughout the drawings, similar symbols and numerals indicate similar items and functions.

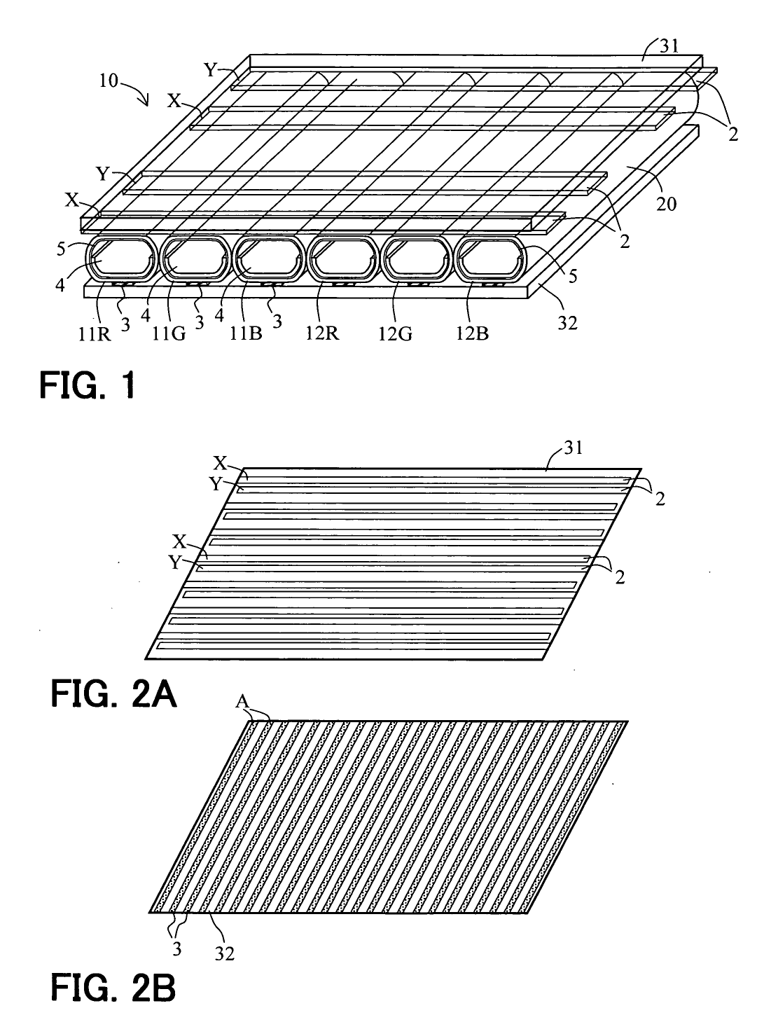

FIG. 1 shows an example of the structure of part of a color display device 10 of a plasma tube array type, in accordance with an embodiment of the present invention. In FIG. 1, the display device 10 includes a plurality of thin, elongated transparent gas discharge tubes 11R, 11G, 11B, 12R, 12G, 12B, . . . , disposed in parallel with each other, a front support plate 31 composed of a transparent front support sheet or thin plate, a rear support plate 32 composed of a transparent or opaque rear support sheet or thin plate, a plurality of pairs of display or main electrodes 2, and a plurality of signal or address electrodes 3. In FIG. 1, a letter X represents a sustain or X electrode, and a letter Y represents a scan or Y electrode. Letters R, G and B represent red, green and blue, which are colors of light emitted by the phosphors. The front and rear support plates 31 and 32 are made of, for example, flexible or elastic PET or glass films or sheets.

The thin elongated gas discharge tubes 11R, 11G, are formed of a transparent, insulating material, e.g. borosilicate glass, Pyrex®, soda-lime glass, silica glass, or Zerodur. The thin, elongated gas discharge tube 11R, 11G, 11B, . . . typically has cross-section dimensions of a tube diameter of 2 mm or smaller, for example a 0.55 mm high and 1 mm wide cross section, and a tube length of 300 mm or larger, and a tube wall thickness of about 0.1 mm.

Typically, phosphor support members having respective red, green and blue (R, G, B) phosphor layers 4 formed or deposited thereon are inserted into the interior discharge spaces of the gas discharge tubes 11R, 11G, 11B, . . . , respectively. Discharge gas is introduced into the interior discharge space of each gas discharge tube, and the gas discharge tube is sealed at its opposite ends. An electron emissive film 5 of MgO is formed on the inner surface of the gas discharge tube 11R, 11G, 11B, . . . , and a support member with a phosphor layer 4 formed thereon is disposed within the gas discharge tube 11R, 11G, 11B, . . . . Alternatively, the respective phosphor layers 4 may be formed on the rear inner surface portions of the gas discharge tubes 11R, 11G, 11B, . . . , without using the support members. The phosphor layers R, G and B typically have a thickness within a range of from about 30 μm to about 50 μm.

The support member is formed of a transparent insulating material, similarly to the gas discharge tubes 11R, 11G, 11B, e.g. borosilicate glass, and has the phosphor layer 4 formed thereon. The support member may be disposed within the glass tube by applying a paste of phosphor over the support member outside the glass tube and then baking the phosphor paste to form the phosphor layer 4 on the support member, before inserting the support member into the glass tube. As the phosphor paste, a desired one of various phosphor pastes known in this technical field may be employed.

The electron emissive film 5 emits charged particles, when it is bombarded with the discharge gas. When a voltage is applied between the pair of display electrodes 2, the discharge gas contained in the tube is excited. The phosphor layer 4 emits visible light by converting thereinto vacuum ultraviolet radiation generated in the de-excitation process of the excited rare gas atoms.

FIG. 2A shows the front support 31 with the plurality of pairs of transparent display electrodes 2 formed thereon. FIG. 2B shows the rear support 32 with the plurality of signal electrodes 3 formed thereon.

The signal electrodes 3 are formed on the front-side surface, or inner surface, of the rear support plate 32, and extend along the longitudinal direction of the gas discharge tubes 11R, 11G, 11B, . . . . The pitch, between adjacent ones of the signal electrodes 3, is equal to the width of each of the gas discharge tubes 11R, 11G, 11B, . . . , which may be, for example, 1 mm. The pairs of display electrodes 2 are formed on the rear-side surface, or inner surface, of the front support plate 31 in a well-known manner, and are disposed to extend across the signal electrodes 3. The width of the display electrodes 2 may be, for example, 0.75 mm, and the distance between the edges of the display electrodes 2 in each pair may be, for example, 0.4 mm. A distance providing a non-discharging region, or non-discharging gap, is secured between one display electrode pair 2 and the adjacent display electrode pairs 2, and the distance may be, for example, 1.1 mm.

The signal electrodes 3 and the pairs of display electrodes 2 are brought into intimately contact respectively with the lower and upper peripheral surface portions of the gas discharge tubes 11R, 11G, 11B, . . . , when the display device 10 is assembled. In order to provide better contact, an electrically conductive adhesive may be placed between the display electrodes and the gas discharge tube surface portions.

In plan view of the display device 10 seen from the front side, the intersections of the signal electrodes 3 and the pairs of display electrodes 2 provide unit light-emitting regions. Display is provided by using either one electrode of each pair of display electrodes 2 as a scan electrode, generating a selection discharge at the intersection of the scan electrode with the signal electrode 3 to thereby select a light-emitting region, and generating a display discharge between the pair of display electrodes 2 using the wall charge formed by the selection discharge on the region of the inner tube surface at the selected region, which, in turn, causes the associated phosphor layer to emit light. The selection discharge is an opposed discharge generated within each gas discharge tube 11R, 11G, 11B, . . . between the vertically opposite scan electrode and signal electrode 3. The display discharge is a surface discharge generated within each gas discharge tube 11R, 11G, 11B, . . . between the two display electrodes of each pair of display electrodes disposed in parallel in a plane.

The pair of display electrodes 2 and the signal electrode 3 can generate discharges in the discharge gas within the tube by applying voltages between them. The electrode structure of the gas discharge tube 11 shown in FIG. 1 is such that the three electrodes are disposed in one light-emitting region, and that the discharge between the pair of display electrodes generates a discharge for display. However, the electrode structure is not limited to such a structure. A display discharge may be generated between the display electrode 2 and the signal electrode 3. In other words, an electrode structure of a type employing a single display electrode may be employed instead of each pair of display electrodes 2, in which the single display electrode 2 is used as a scan electrode so that a selection discharge and a display discharge (opposed discharge) are generated between the single display electrode 2 and the signal electrode 3.

In gas discharge groups 11R, 11G and 11B according to the conventional technique, a phosphor layer 4 is formed on the inner surface of a support member on the rear side of the interior of each gas discharge tube 11R, 11G, 11B. For gas discharge tubes each having a tube wall thickness of 100 μm and a cross-section which is perpendicular to the length direction of the tube, such that a width of the cross-section is 1.0 mm and a height of the cross-section is 0.5 mm, the opposite discharge firing voltage between one display electrode 2 and a signal electrode 3 exhibits the following characteristics.

Due to difference in characteristics of different color-emitting phosphor materials, the firing voltage for opposite discharge for a red-emitting gas discharge tube 11R is the lowest, e.g. about 280 V, and also the firing delay time is the shortest, when the same voltage as the other color emitting gas discharge tubes is applied. The firing voltage for opposite discharge in the green-emitting gas discharge tube 11G is the highest, e.g. about 310 V, and also the firing delay time is the longest, when the same voltage as the other color emitting gas discharge tubes is applied. The opposite discharge firing voltage for the blue-emitting gas discharge tube 11B lies between the two and nearer to the firing voltage for the red-emitting gas discharge tube 11R, e.g. about 285 V, and also the firing delay time is between the two, when the same voltage as the other color emitting gas discharge tubes is applied. However, it is desirable that the difference in firing voltage for opposite discharge and difference in firing delay time between the gas discharge tubes 11R, 11G and 11B be small. The largest difference in firing voltage for opposite discharge between the gas discharge tubes 11R, 11G and 11B is usually innegligibly large, e.g. about 30 V. Thus, when the difference of the firing voltage from the set applied voltage is large, excessive discharge may occur, causing erasing discharge, which reduces wall charge, which may cause failure of light emission.

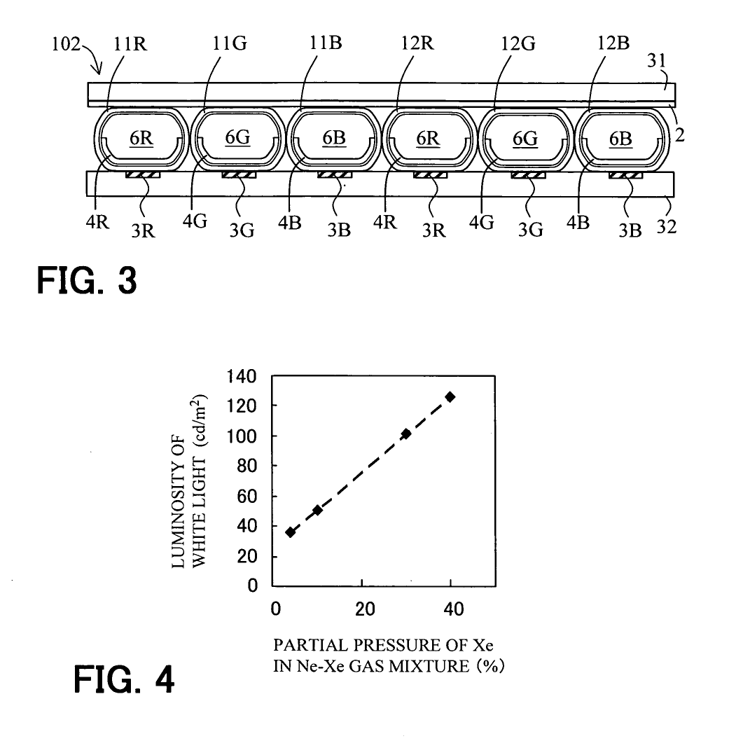

FIG. 3 shows the cross-section of the structure of a display device 102 in a plane perpendicular to the longitudinal direction, in accordance with the embodiment of the invention. In the display device 102, phosphor layers 4R, 4G and 4B are formed on the rear-side, inner surface portions of gas discharge tubes 11R, 11G and 11B, respectively, and the gas discharge tubes are thin tubes having a tube thickness of 0.1 mm, a width in the cross-section of 1.0 mm, a height in the cross-section of 0.55 mm, and a length of from 1 m to 3 m. For example, the red-emitting phosphor 4R may be formed of an yttria based material ((Y.Ga)BO₃:Eu), the green-emitting phosphor 4G may be formed of a zinc silicate based material (Zn₂SiO₄:Mn), and the blue-emitting phosphor 4B may be formed of a BAM based material (BaMgAl₁₀O₁₇:Eu). In FIG. 3, the rear support plate 32 is bonded or fixed to bottom surfaces of the red-emitting gas discharge tubes 11R, 11G, 11B, . . . . The signal electrodes 3R, 3G, 3B are disposed on the bottom surfaces of the gas discharge tubes 11R, 11G, 11B and on an upper surface of the rear support plate 32.

Discharge gas 6R in the gas discharge tubes 11R and 12R, discharge gas 6G in the gas discharge tubes 11G and 1GR, and discharge gas 6B in the gas discharge tubes 11B and 12B are mixtures or combinations of different gases and have different gas compositions. In other words, they are different gas mixtures, and/or the gas components are in different partial pressure ratios or ratios.

FIG. 4 shows the relationship of luminosity of white light to a partial pressure ratio of xenon (Xe) gas in a gas mixture of neon (Ne) and xenon in the gas discharge tubes 11R, 11G, 11B, . . . , including color phosphor layers of different materials. It is seen that, as the ratio of the Xe gas increases, the luminosities of the gas discharge tubes 11R, 11G, 11B, . . . , increase.

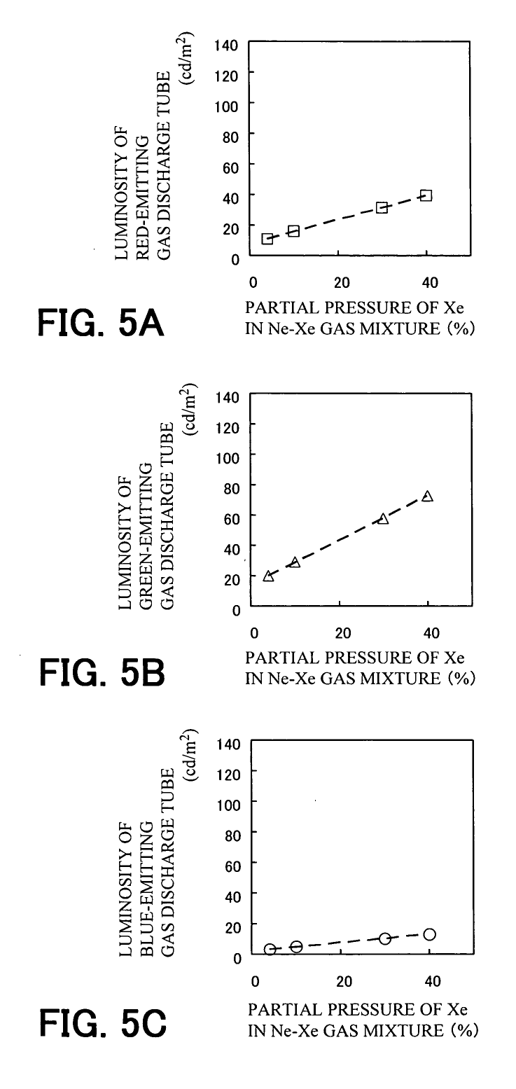

FIGS. 5A, 5B and 5C show the relationship of luminosity to a partial gas ratio of Xe gas in a gas mixture of Ne and Xe in the respective ones of the gas discharge tubes 11R, 11G and 11B. It is seen that, in all of the gas discharge tubes 11R, 11G and 11B, as the partial pressure ratio of the Xe gas increases, the luminosity increases. With the same Xe gas partial pressure ratio, the luminosity of the gas discharge tube 11B having a blue-emitting phosphor layer is the lowest, the luminosity of the gas discharge tube 11G having a green-emitting phosphor layer is the highest, and the luminosity of the gas discharge tube 11R having a red-emitting phosphor layer is in-between.

On the other hand, with the same gas mixture ratio or composition employed for the gas discharge tubes 11R, 11G and 11B, the luminosity of the blue-emitting gas discharge tube 11B tends to be too low. It is desirable for the blue-emitting gas discharge tube 11B to have a higher luminosity in order to obtain a high color temperature. The luminosity of the red-emitting gas discharge tube 11R and the luminosity of the green-emitting gas discharge tube 11G may be adjusted if necessary.

Accordingly, in FIG. 3, in order to obtain high luminosity of white light by adjusting the white balance, the blue-emitting gas discharge tubes 11B and 12B are filled with a large amount of Xe gas, which largely contributes to the generation of excited particles, so as to provide a relatively higher Xe gas partial pressure ratio, relative to the read- and green-emitting gas discharge tubes. For example, Ne gas and Xe gas are mixed to have partial pressure ratios of 90% and 10%, respectively. The red-emitting gas discharge tubes 11R and 12R and the green-emitting gas discharge tubes 11G and 12G are filled with such a large amount of Xe gas as to provide a relatively lower Xe gas partial pressure ratio, relative to the blue-emitting gas discharge tubes. For example, Ne gas and Xe gas are mixed to have partial pressure ratios of 96% and 4%, respectively.

The gas mixture to be put in the gas discharge tubes 11R, 11G, 11B, . . . , may include from two to five component gases selected from a group consisting of neon (Ne), xenon (Xe), helium (He), krypton (Kr) and argon (AR) gases. The partial pressure ratio of Ne gas in the gas mixture is smaller than 100%, and typically is from 60% to 99%. The partial pressure ratio of one or the sum of from two to four gases selected from Xe, He, Kr and Ar gases is not smaller than 0% and is typically within a range of from 1% to 40%.

Ne gas is used as a major constituent gas in the gas discharge tubes 11R, 11G, 11B, . . . . In commercially available plasma display panels (PDPs), the partial pressure ratio of Ne gas is typically from about 80% to about 96%. For example, a gas mixture having a total pressure of 500 Torr contains Ne gas at a partial pressure ratio of 96% and Xe gas at a partial pressure ratio of 4 Xe gas provides excited species (Xe*, Xe**, Xe₂*) generating ultraviolet radiation causing a phosphor to emit light. The gas discharge tubes 11R, 11G, 11B, . . . , mainly use such ultraviolet radiation to cause the phosphors to emit light, and hence Xe gas typically is an essential constituent gas. A higher partial pressure ratio of Xe gas tends to improve the luminous efficiency, and the luminosity tends to increase.

A higher partial pressure ratio of He gas in the gas mixture slightly increases the luminosity. Also, when He gas is mixed with other gas, the firing voltage decreases. For example, the firing voltage of a gas mixture containing Ne gas, Xe gas and He gas to have partial pressure ratios of 86%, 4% and 10%, respectively, is lower than the firing voltage of a gas mixture containing Ne gas and Xe gas to have partial pressure ratios of 96% and 4%, respectively. Further, a higher partial pressure ratio of He gas can decrease the time delay from the application of a voltage to the firing, so that the period of time required for addressing voltage application can be shortened.

The gas discharge tubes 11R and 12R potentially have the lowest firing voltage and have the shortest firing time delay. The gas discharge tubes 11B and 12B potentially have the next lower firing voltage and have the next shorter firing time delay. The gas discharge tubes 11G and 12G potentially have the highest firing voltage and have the longest firing time delay. Accordingly, a larger amount, e.g. 10%, of He gas may be introduced into the gas discharge tubes 11G and 12G, with a smaller amount, e.g. 5%, of He gas introduced into the gas discharge tubes 11B and 12B, and with no or a little, e.g. 0.5%, He gas introduced into the gas discharge tubes 11R and 12R.

Kr gas and Ar gas can lower the firing voltage when they are mixed with other gas. For example, the firing voltage for a gas mixture containing Ne gas of a partial pressure ratio of 91%, Xe gas of a partial pressure ratio of 4%, and Ar gas of a partial pressure ratio of 5% is lower than that for a gas mixture containing Ne gas of a partial pressure ratio of 96% and Xe gas of a partial pressure ratio of 4%.

For example, the partial pressure ratios of Ne gas, Xe gas, He gas, and Kr or Ar gas in the red-emitting gas discharge tubes 11R and 12R may be 95%, 4%, 1% and 0%, respectively. The partial pressure ratios of Ne gas, Xe gas, He gas, and Kr or Ar gas in the green-emitting gas discharge tubes 11G and 12G may be 90%, 4%, 1% and 5%, respectively. The partial pressure ratios of Ne gas, Xe gas, He gas, and Kr or Ar gas in the blue-emitting gas discharge tubes 11B and 12B may be 92%, 4%, 1% and 3%, respectively.

The above-described embodiments are only typical examples, and their combination, modifications and variations are apparent to those skilled in the art. It should be noted that those skilled in the art can make various modifications to the above-described embodiments including application to a common color plasma display panel of a three-electrode surface discharge type, without departing from the principle of the invention and the accompanying claims.

What is claimed is:

1. A color display device comprising: a plurality of gas discharge tubes disposed side by side, said gas discharge tubes having phosphor layers of different materials for respective colors disposed therein and containing discharge gas therein, said gas discharge tubes each having a plurality of light-emitting points disposed along the length thereof; a plurality of display electrodes disposed on display-side surfaces of said gas discharge tubes; and a plurality of signal electrodes disposed on the rear sides of said respective gas discharge tubes; wherein
the discharge gas in each of said plurality of gas discharge tubes comprises a mixture of a plurality of different gases, and the gas discharge tubes including respective different materials for said phosphor layers have respective different compositions of the plurality of different gases, each composition of the plurality of different gases having such respective partial pressure ratios as to raise a color temperature.

2. The color display device according to claim 1, wherein said plurality of gas discharge tubes comprise red-emitting, green-emitting and blue-emitting gas discharge tubes, a combination of different gases of the discharge gas for the blue-emitting gas discharge tubes being different from a combination of different gases of each of the discharge gases for the red-emitting and green-emitting gas discharge tubes.

3. The color display device according to claim 1, wherein said plurality of gas discharge tubes comprise red-emitting, green-emitting and blue-emitting gas discharge tubes, the discharge gas for the blue-emitting gas discharge tubes having partial pressure ratios of the different gases thereof at least partly different from partial pressure ratios of the different gases of the discharge gases for the red-emitting and green-emitting gas discharge tubes.

4. The color display device according to claim 1, wherein the discharge gas mixture of each gas discharge tube comprises neon gas and one or more of gases selected from a group consisting of xenon, helium, krypton and argon gases.

5. The color display device according to claim 1, wherein said plurality of gas discharge tubes comprise red-emitting, green-emitting and blue-emitting gas discharge tubes, and a partial pressure ratio of xenon gas in the discharge gas in said blue-emitting gas discharge tubes being larger than a partial pressure ratio of xenon gas in each of the discharge gases in said red-emitting and green-emitting gas discharge tubes.

6. The color display device according to claim 4, wherein said plurality of gas discharge tubes comprise red-emitting, green-emitting and blue-emitting gas discharge tubes, and said discharge gas comprises a mixture of neon gas, xenon gas and one or more of gases selected from a group consisting of helium, krypton and argon gases, a partial pressure ratio of the xenon gas in the discharge gas in said blue-emitting gas discharge tubes being larger than a partial pressure ratio of the xenon gas in each of the discharge gases in said red-emitting and green-emitting gas discharge tubes.
